(19) United States
(12) Patent Application Publication
(10) Pub. No.: US 2006/0176481 A1
(43) Pub. Date: Aug. 10, 2006

(54) End-column fluorescence detection for capillary array electrophoresis

(75) Inventors: Craig R. Forest, Somerville, MA (US); Ian Hunter, Lincoln, MA (US); Nathan B. Ball, Cambridge, MA (US); William G. Thilly, Winchester, MA (US)

Correspondence Address: BROMBERG & SUNSTEIN LLP, 125 SUMMER STREET, BOSTON, MA, 02110-1618, US

(73) Assignee: Massachusetts Institute of Technology

(21) Appl. No.: 11/351,669

(22) Filed: Feb. 10, 2006

Related U.S. Application Data
(60) Provisional application No. 60/651,681, filed on Feb. 10, 2005.

(51) Int. Cl. G01N 21/00; G01N 21/64

(52) U.S. Cl. 356/344; 204/452; 204/603; 356/417

(57) ABSTRACT

A massively parallel electrophoresis system comprised of capillaries, with means for parallel imaging of the capillary ends. The capillaries are aligned with parallel longitudinal axes and a set of ends that are substantially coplanar. The electrophoresis system has a source of excitation radiation for illuminating the ends while an imaging optical arrangement places substantially coplanar loci, one per capillary, within a focal region of the imaging optical arrangement. A detector module receives electromagnetic radiation that is emitted by fluorophores within the capillaries upon excitation by the excitation radiation and transmitted to the detector module by way of the imaging optical arrangement. A manifold may terminate the array of electrophoresis capillaries, wherein the manifold has a platen with a plurality of recessions for receiving each of a the ends of the array of capillaries, and a septum disposed adjacent to the platen for penetration by the ends of the array of capillaries when inserted into the platen. Electrophoresis products may be separated by segregating effluent from one or more capillaries of the array.

The present application claims priority from U.S. Provisional Patent Application Ser. No. 60/651,681, filed Feb. 10, 2005, which application is incorporated herein by reference.

### TECHNICAL FIELD

The present invention relates to a device and method for parallel optical detection of fluorescence from the ends of multi-capillary arrays performing electrophoretic separations.

### BACKGROUND OF THE INVENTION

Inroads have been made toward increasing the throughput of electrophoresis systems for separating and identifying DNA molecules and other macromolecules, as typically practiced for sequencing and genotyping operations. Typical systems employ the migration of samples, in applied electric fields, through some number of parallel capillaries or channels, and detection of fluorescence or ultra-violet (UV) absorption in molecules selectively excited by optical illumination. Each of the prior art systems, however, suffers from notable limitations on scalability—regrettable in view of clearly advantageous research avenues that would be opened were truly high sample volume throughputs enabled.

Examples of parallel-channel electrophoresis systems that have been implemented or that have been proposed include those in which multiple streams are scanned by a confocal system of time-varying focal displacement and those in which electrophoresis lanes are arrayed radially on a chip, as described by Emrich et al., Microfabricated 384 Lane Capillary Array Electrophoresis Bioanalyzer for Ultra High-Throughput Genetic Analysis, 74 Anal. Chem., 5076-83, (2002). In other prior art systems, one or more rows of capillaries are aligned side-by-side, with parallel axes and co-planar ends, and are side-illuminated by a laser, or other high-intensity source. Light from the illumination source traverses the capillaries sequentially; i.e., the light illuminating the second capillary has already propagated through the first. Thus, light incident on the second capillary is less intense, due to attenuation, than light incident on the first. Where two-dimensional arrays of capillaries have been proposed, a similar limitation exists, in that light that illuminates a second row has already traversed a first row. An example of this configuration is shown in FIG. 5 of U.S. Pat. No. 6,613,212, to Siebert et al., where the excitation laser beam, denoted F, is focused weakly on an array of capillaries C, and traverses each row sequentially. In this configuration, the exciting radiation is attenuated to a significant degree upon passing through each capillary. Thus, the illumination intensity incident on each successive row decreases exponentially, in general, such that the number of rows that can be illuminated with sufficient optical intensity is limited. Moreover, homogeneity of the illuminating field is further impaired by the variation in refractive index of the successive media through which the beam passes. One consequence of this is moderate refocusing of the illumination beam upon each traversal of a capillary wall.

Strategies have been proposed to overcome the effects of capillary wall reflection and refraction in the readout of fluorescence by flowing the fluorescent molecules, at the outputs of their migration through respective capillaries, into a sheath flow cuvette. Such systems, as commercialized by Applied Biosystems, of Foster City, Calif., are limited by the distance over which the excitation laser beam remains collimated. A two-dimensional version of the sheath-flow stratagem, described by Zhang et al., Two-Dimensional Direct-Reading Fluorescence Spectrograph for DNA Sequencing by Capillary Array Electrophoresis, 73 Anal. Chem. 1234-39 (2001), is limited in scalability by the size of the collection lens required to image the capillaries onto the focal plane of a detector, moreover, large laser powers are, again, required, to excite any large number of parallel channels.

In addition to the limitations on scalability imposed, in the prior art, by the requisite size of detectors, collection optics, or optical power constraints of excitation lasers, a further, and considerable, limitation is the failure to provide for or permit collection, or sequestration, of molecules effluent from respective electrophoresis channels. Post-processing analysis is valuable in many applications and is unavailable where fluorescence detection occurs outside the capillaries in a common pooled buffer medium and is impractical when detection occurs at a distance away from the distal end of the capillaries.

Moreover, the use of electrodes, at each end of the array of electrophoresis capillaries, that is common to all the channels, precludes channel-to-channel variation of applied potentials.

Martin et al. (International Patent Publication No. WO2004/059312) suggests the use of an array of optical collection surfaces, such as Winston cones, that protrude beneath the lower surface of a platen, for coupling light, by non-imaging means, into, and out of, the ends of an array of capillaries. According to the teachings of Martin et al., the capillaries extend into the volume encompassed by each of the collection surfaces, since the optical focus is disposed within that volume. Additionally, beam-shaping elements (including microlenses) may be located either with the platen itself or on its upper surfaces, however the coupling of light between free space and the capillary is, in all cases, non-imaging, and is achieved by means of the Winston cone, or other collection surface structure. Imaging is advantageous for massively parallel capillary electrophoresis. Imaging prevents crosstalk between the capillary channels, thus increasing signal-to-noise ratio and permitting a greater capillary packing density and increased sensitivity.

### SUMMARY OF THE INVENTION

Embodiments of the present invention that are described herein are typically, though not exclusively, used in conjunction with biological molecules, which, for present purposes, are taken to include nucleic acids (such as modified or unmodified nucleotides, DNA, RNA, PNA), or polymers of amino acids, or proteins, or charged complex carbohydrates, etc.

In accordance with preferred embodiments of the invention, there is provided a massively parallel electrophoresis system. The electrophoresis system has a plurality of capillaries, each capillary characterized by a longitudinal axis, a first end and a second end, the capillaries aligned such that their longitudinal axes are parallel and their first ends are substantially coplanar. The electrophoresis system, moreover, has a source of excitation radiation for illuminating the first ends of the plurality of capillaries and an imaging optical arrangement having one or more focal regions, the imaging optical arrangement disposed at a displacement with respect to the substantially coplanar loci so as to place each locus within a focal region of the imaging optical arrangement. Finally, the electrophoresis system has a detector module for receiving electromagnetic radiation emitted by fluorophores within the capillaries upon excitation by the excitation radiation and transmitted to the detector module by way of the imaging optical arrangement.

In accordance with various alternate embodiments of the invention, the optical arrangement of the electrophoresis system may be an array of imaging optical elements disposed at a displacement with respect to the substantially coplanar loci so as to place each locus within a focal region of one of the imaging optical elements. The optical arrangement may also be a telescoping imaging system or a large-format relay lens.

In accordance with another aspect of the invention, an apparatus is provided for optical interrogation, generally, of a plurality of substantially coplanar loci. The apparatus has an imaging optical arrangement having one or more focal regions, the imaging optical arrangement disposed at a displacement with respect to the substantially coplanar loci so as to place each locus within a focal region of the imaging optical arrangement. The apparatus also has a source for illuminating each of the plurality of substantially coplanar loci via the optical arrangement and an optical detector for detecting light imaging each of the plurality of substantially coplanar loci after said light has been collected by the imaging optical arrangement. The optical arrangement may include an array of imaging optical elements, each of which is characterized by an area, a numerical aperture, and a focal region.

In accordance with various alternate embodiments of the invention, the optical elements are reflecting elements, such as parabolic reflectors, or they may be lenslets. The area and numerical aperture of each optical element may be chosen so as to provide an increase in optical collection solid angle for each of the substantially coplanar loci, and the numerical aperture of each optical element, in particular, may exceed 0.3. The source of illumination may include an LED array, and may generally include an array of incoherent light sources and an optical diffuser. The optical detector may be a CCD array, and, more particularly, an impact-ionizing CCD array.

In accordance with yet a further aspect of the present invention, a method is provided for manufacturing an array of lenslets. The method has the steps of fashioning a plurality of détentes in a mold and injecting acrylic into the mold. The step of fashioning the détentes may include one or more of the steps of milling with a ball-end milling tool, investment casting, single point diamond turning, or grinding.

In accordance with a further aspect still, a manifold is provided for terminating an array of electrophoresis capillaries. The manifold has a first platen having a plurality of recessions for receiving each of a plurality of ends of the array of capillaries, a conductive layer covering one face of the first platen, and a septum disposed adjacent to the conductive layer for penetration by the ends of the array of capillaries when inserted into the first platen. Alternatively, the platen itself may be conductive. The manifold may also have a transparent platen adjacent to the first platen, for admitting light for optical interrogation of the ends of the array of capillaries. The septum may be a silicone layer and may retain material from each of the array of capillaries in the manifold upon withdrawal of the array of capillaries.

In accordance with another aspect of the present invention, a system is provided for performing electrophoresis on a plurality of samples. The system has a plurality of capillaries, each capillary having a first end and a second end, and each capillary containing a sample loaded into a gel. Moreover, the system has a terminating manifold, at either or both ends. The terminating manifold has a platen with multiple recessions for receiving each of a plurality of first ends of the array of capillaries, a conducting layer covering the platen adjacent to each or several of the plurality of recessions, and a septum disposed adjacent to the conductive layer for penetration by the first ends of the array of capillaries when inserted into the first platen. Finally, the manifold contains at least a portion of a circuit for applying an electrical potential between the first ends of the array of capillaries and the second ends of the array of capillaries.

In accordance with one more aspect of the invention, a method is provided for separating products from an electrophoresis run. The method has steps including:
a. injecting gel into an array of capillaries, the capillaries characterized by a proximal end and a distal end;
b. loading dye-labeled organic sample into the proximal ends of each of the capillaries;
c. terminating the distal ends of the capillaries in a terminating manifold having a buffer well corresponding to each capillary;
d. applying an electrical potential across each of the capillaries;
e. illuminating the distal ends of each capillary of an array of capillaries with dye-exciting light; and
f. upon detecting a fluorescence signal from at least one of the capillary ends, segregating effluent from one or more capillaries of the array.
   In accordance with one of the alternate embodiments of the invention, the step of segregating effluent may include withdrawing the array of capillaries from the terminating manifold, thereby retaining a fraction of the organic sample in each of a plurality of buffer wells.

### BRIEF DESCRIPTION OF THE DRAWINGS

The invention will more readily be understood by reference to the following description taken with the accompanying drawings in which:

FIG. 1A is a schematic depiction of a two-dimensional capillary end-column imaging apparatus, in accordance with embodiments of the present invention;

FIG. 1B is an external view of the embodiments of the present invention depicted in FIG. 1A;

FIG. 2 shows various views of an LED array in accordance with embodiments of the present invention;

FIG. 3A shows a typical light intensity budget;

FIG. 3B shows typical spectra of the excitation radiation and fluorophore absorption;

FIG. 4 is a perspective view of a transluminated lenslet array in accordance with an embodiment of the invention;

FIG. 5 shows an injection mold for fabrication of a lenslet array;

FIG. 6 is a set of equations pertinent to the design of the imaging optical elements focused on the capillary ends, in accordance with embodiments of the present invention;

FIG. 7 is a schematic of the readout operation of an ionization impact CCD array;

FIG. 8 shows demonstrated sensitivity to fluorophore concentration;

FIG. 9 is a schematic of a parallel capillary array electrophoresis system in accordance with embodiments of the present invention;

FIG. 10 shows a cross-sectional schematic and a perspective view of a buffer array in accordance with embodiments of the present invention;

FIG. 11A shows a top view of a microfluidic channel plate arrangement with segregation zones interfaced to ends of an array of capillaries, for sequestration of molecular effluent, in accordance with embodiments of the present invention; and

FIGS. 11B and 11C show cross sections of the microfluidic channel plate arrangement of FIG. 11A along lines B-B and A-A, respectively.

### DETAILED DESCRIPTION OF PREFERRED EMBODIMENTS

Various techniques of optical identification or analysis of materials entail the excitation of a sample with light of one wavelength (or band of wavelengths) and detection of subsequent emission at the same or other wavelengths. Such techniques include scattering modalities such as Raman spectroscopy, as well as fluorescence, where a target molecule is labeled with a fluorophore (such as the Alexa 488 dye that is used herein for descriptive purposes and without limitation) that emits light at a characteristic emission wavelength when the fluorophore is excited by exciting radiation of equal or greater energy to the emitted fluorescence.

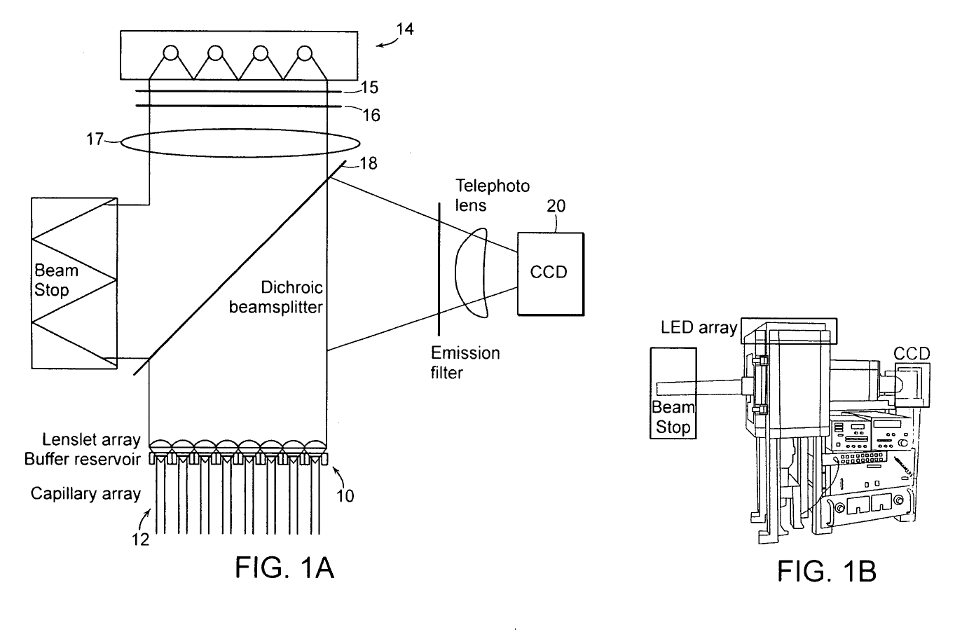

Some basic elements that may be employed in the practice of the present invention are now introduced with reference to FIG. 1A, where an apparatus for optically interrogating a plurality of loci is shown. The loci to be interrogated lie substantially within a focal plane 10 that encompasses, for example, the ends of an array of substantially parallel capillaries 12. The “loci” are a plurality of regions that comprise a subset of focal plane 10. (It should be noted that the extension of the optical configuration shown to encompass the case of non-coplanar loci entails designing the foci to lie in designated regions in three-dimensional space, and is within the ken of a person of ordinary skill in the optical arts and within the scope of the present invention as described herein and as claimed in any appended claims. Thus, the terms “focal plane” and “coplanar” are used for convenience of description and understanding of the reader, however they are used without limiting intent.)

In the case where the loci to be interrogated are the ends of electrophoresis capillaries, as shown in the embodiment of FIG. 1A, the capillaries 12 may be terminated in a buffer well array, as shown, and as described below, for example, or in a common buffer reservoir.

The loci are illuminated by a source 14 of exciting electromagnetic radiation. The source may provide visible or UV photons, for example, within a specified band of wavelengths tailored to the intended application. Thus, for example, illumination may be provided over the range of 480-490 nm, by spectral filtering of an LED array source with an excitation filter 15, as further described below. Light from source 14 is diffused, such as by an holographic diffuser 16, and may also be shaped by shaping optics such as collector lens 17, before traversing a dichroic beamsplitter 18, typically coated to pass some fraction of the incident excitation light. The excitation illumination is then focused by an array of optical elements, preferably a lenslet array, onto respective ends of the capillaries 12.

When molecules tagged with a fluorophore appear at the end of a capillary and within the focal region of a lenslet, a fraction of the emitted fluorescent radiation subtended by the corresponding lenslet is recollimated, and preferentially reflected, at the dichroic beamsplitter, in the direction of a detector array 20. The fluorescence beam, typically at a wavelength some 25 nm longer than the peak of the excitation spectral band, is transmitted through an emission filter designed to reject stray radiation remnant, for example, from the excitation beam. Moreover, light deflected from the excitation beam on its pass through the dichroic beamsplitter is absorbed by a beam stop, thereby enhancing the fluorescence signal with respect to any residual background. The fluorescence beam is imaged, such as by a telephoto lens, on the focal plane of detector array 20. Detector array 20 is preferably a charge-coupled device (CCD) array, as further described below.

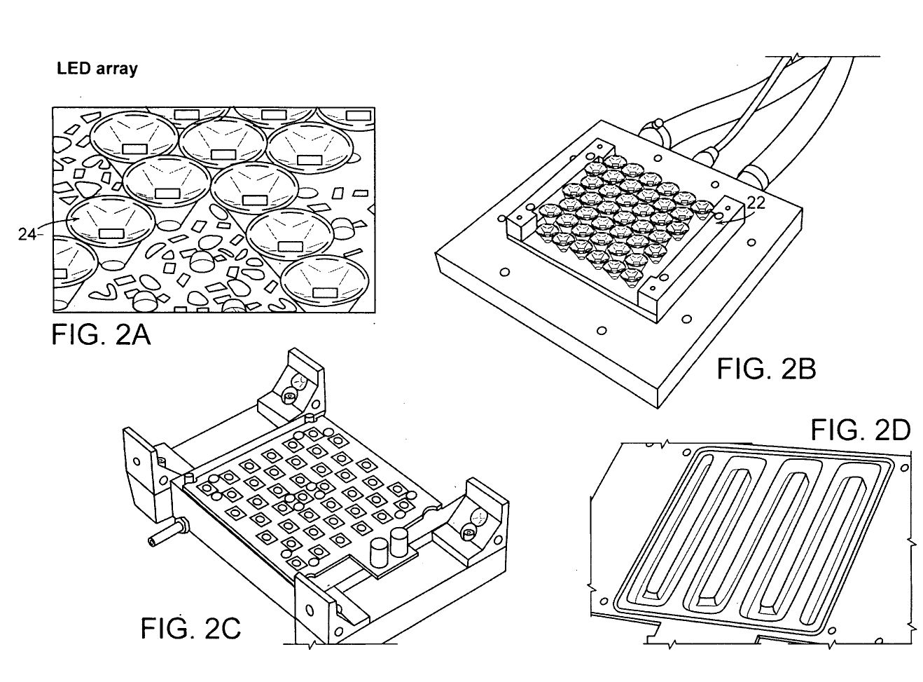

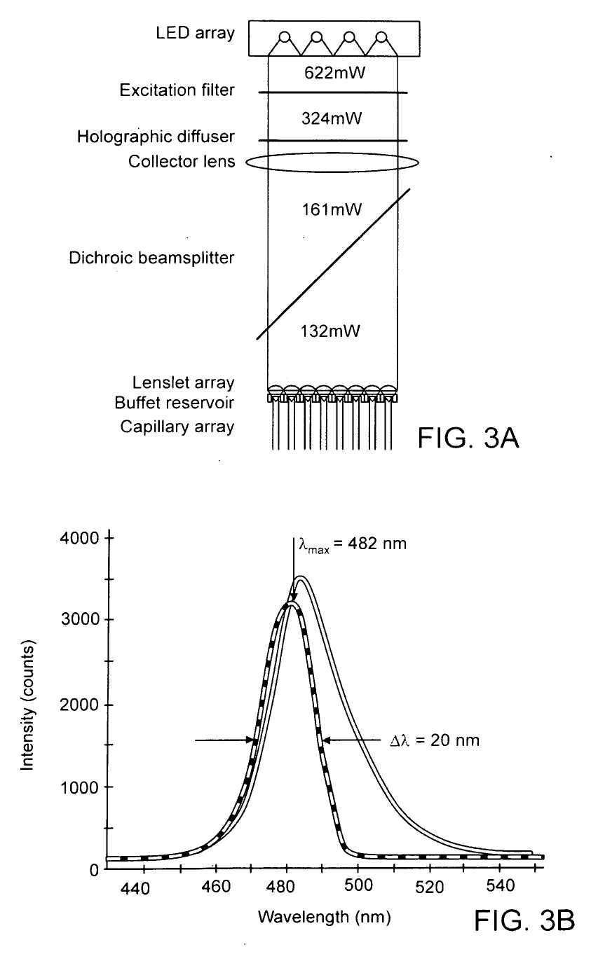

Source 14, in accordance with a preferred embodiment of the invention, is a water cooled array 22 of blue light emitting diodes (LEDs) 24 shown in FIG. 2. The number of LEDs in the configuration shown is 42, however the source is readily scaled to requisite area and intensity and thus imposes no restriction on the parallelism that may be achieved using the present invention. A typical budget of excitation light intensity through the system is shown in FIG. 3A, while the spectra of the filtered excitation source and of the absorption by fluorophores are compared in FIG. 3B.

Emission by the array of discrete LEDs that comprises source 14 is diffused so as to provide more uniform illumination of the lenslet array. Various methods are known in the art for diffusing light and may be employed by those skilled in the art. Those methods known, or yet to be developed, fall within the scope of the present invention. Standard ground glass or opal glass diffusers have been found to produce a diffuse light area exceeding the requirements of the system, thereby reducing optical efficiency or increasing cost and complexity. Holographic diffusers provide for superior control of the angular divergence of the diffused illumination.

The performance of the beam stop in preventing return of any excitation radiation into the field of view of the detector array provides for the limiting dark count that determines, in turn, the signal-to-noise ratio of the system. Dark counts on the order of 5 counts per second per pixel have been achieved in the system to date.

Illumination from excitation source 14 is focused substantially at the ends of each of the capillaries 12 of the capillary array by means of an array of discrete imaging optical elements. The term “imaging,” as used herein and in any appended claims, refers, in the technical optical sense, to conformal mapping points in an image plane one-to-one onto points in a focal plane. Thus, an imaging optic may be a refractive optical element such as a lenslet, or it may be a reflective optical element such as a mirrorlet. It is not, however, any reflective surface of rotation in which information regarding the relative position of incident rays is lost.

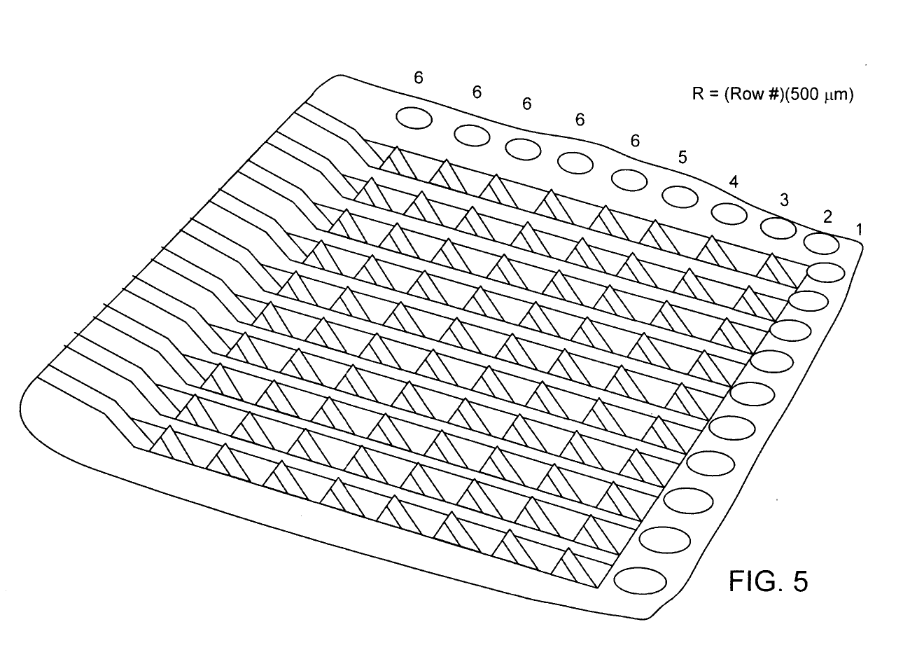

In one preferred embodiment of the invention, a lenslet array is employed, as shown in FIG. 5, focusing light incident from above onto respective focal regions of brightness on the surface below the array. While a 5×5 array is shown by way of example, arrays of any dimension are within the scope of the present invention. An advantage of the technology disclosed in this invention is the scalability to large numbers of elements.

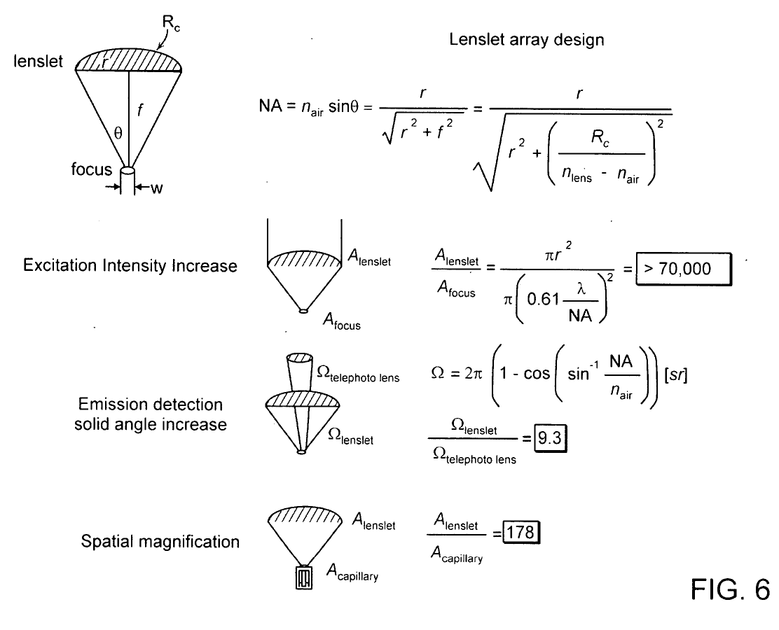

Considerations in the design of a lenslet are shown in FIG. 6. The numerical aperture (NA) is defined as NA=nₐᵢᵣ sin θ, where θ is the half angle of the light collection cone between the lenslet and its focus, and nₐᵢᵣ is the index of refraction of air (substantially, unity). (Extension to the case of immersion optics is straightforward and similarly encompassed within the scope of the present invention.) The lenslets are typically on the order of 1 mm in diameter, though the size is merely one of design choice, based on the spacing of capillaries in the capillary array, and any size is within the scope of the invention. The present design is based on capillaries of outside diameter (OD) of approximately 350 μm, and approximately 75 μm inside diameter (ID), however the tradeoff of the multiplex advantage of multiple channels with detectability limits based on volume of sample traversing each channel is one within the ken of a person of skill in the art of designing electrophoresis systems.

Typical numerical aperture of the lenslets is up to approximately 0.44, though other numerical apertures are within the scope of the invention. The characteristic dimension of the focus, at 480 nm, is on the order of 3 μm. The lenslet array, as shown in FIG. 6, provides the advantage of multiplying the intensity (in ergs-mm⁻²) of the excitation beam at the focus (i.e., at the end of the capillary addressed) by a factor exceeding 70,000, relative to excitation with a collimated beam. Moreover, the solid angle of emission by the fluorophore, as imaged onto the detector focal plane, is increased by a factor of order ˜10 relative to that achievable with a telephoto lens alone. Moreover, the area (in the detector focal plane, for example) subtended by the capillary and as imaged by its respective lenslet, is magnified by a factor of order 2×10².

At high numerical apertures, saturation of the fluorescent signal may occur and further tightening of the focus produces successively smaller increases in signal. Under these conditions, higher signal-to-noise ratios may be obtained with a larger illuminated cross section and greater depth of focus, as achieved using lower NA lenslets.

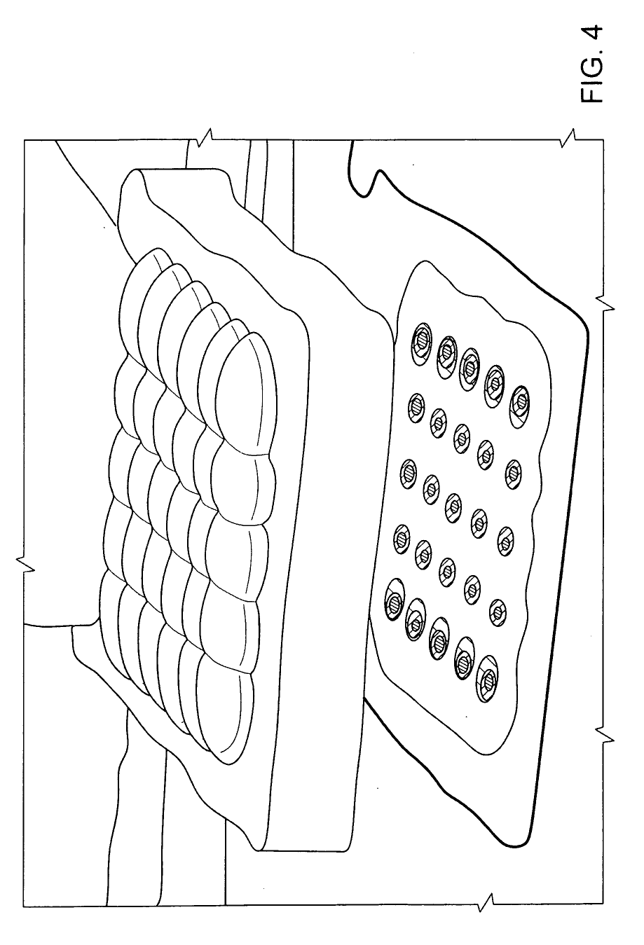

The lenslet array shown in FIG. 4 is fabricated from injection molded acrylic. Other materials and fabrication techniques are within the scope of the present invention, however. The injection mold itself, shown in FIG. 5, may be formed with a ball end mill, by investment casting, single point diamond turning, or grinding, for example. Lenslets may also be manufactured, for example, by microjet printing, as described, for example, by Cox et al., in Micro-jet Printing of Refractive Microlenses, Optical Society of America Topical Meeting on Diffractive Optics and Micro-Optics, Kona, H A (June, 1998), which paper is incorporated herein by reference. Other manufacturing techniques within the scope of the present invention include die casting and laser ablation, such as by means of a CO₂ laser.

It is to be understood that while the use of an array of optical elements such as lenslets is to be preferred under some circumstances, it is also possible, within the scope of the invention, to use a large-format relay lens or telescopic imaging system of sufficient numerical aperture, generally, to collect emission with adequate signal-to-noise ratio.

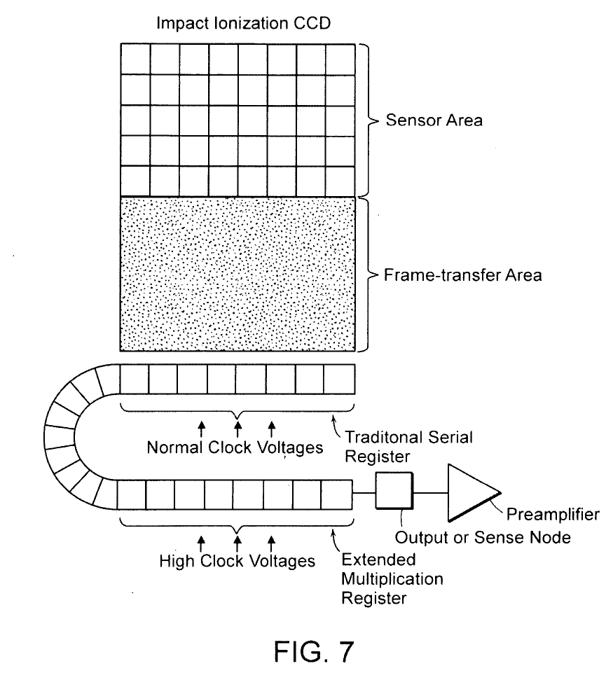

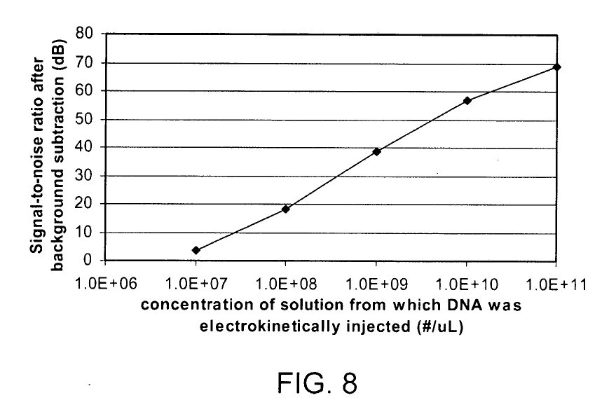

Detection of light emitted by fluorophores at the capillary ends, as imaged by the lenslet array, is performed by a CCD array, cooled to about −20° C., in one embodiment of the present invention. In an alternate embodiment of the invention, CCD readout may be performed using the on-chip multiplication gain achieved using known impact ionization techniques, by extending the shift register to contain a gain section, depicted in FIG. 7 as the Extended Multiplication Register. Any photoimaging modality is encompassed within the scope of the present invention.

Sensitivity obtained using an embodiment of the present invention is shown in the graph of FIG, 8, where the achieved signal-to-noise ratio (SNR) for detection of analytes after electrophoresis is plotted as a function of injection solution concentration. The solution concentration refers to the number of fluorescently-labeled (Alexa fluor 488) DNA molecules in the solution from which the capillary was electrokinetically loaded. Subtraction refers to differencing the blank field CCD image from the current image to obtain a differential image.

Resolution in electrophoresis derives from precise measurement of the concentration (of tagged molecules) as a function of time. Traversal by the sample of the entire length of the capillary takes on the order of half an hour, and digital signal processing requirements impose a requisite sampling rate with a Nyquist criterion of greater than 0.2 Hz. Under the experimental conditions described above, a sampling rate of 3 Hz has been achieved with a signal-to-noise ratio of 10. While all discussion herein refers to continuous detection with shift register readout of a CCD, it is to be understood that techniques capable of temporal resolution of induced fluorescence are also within the scope of the present invention.

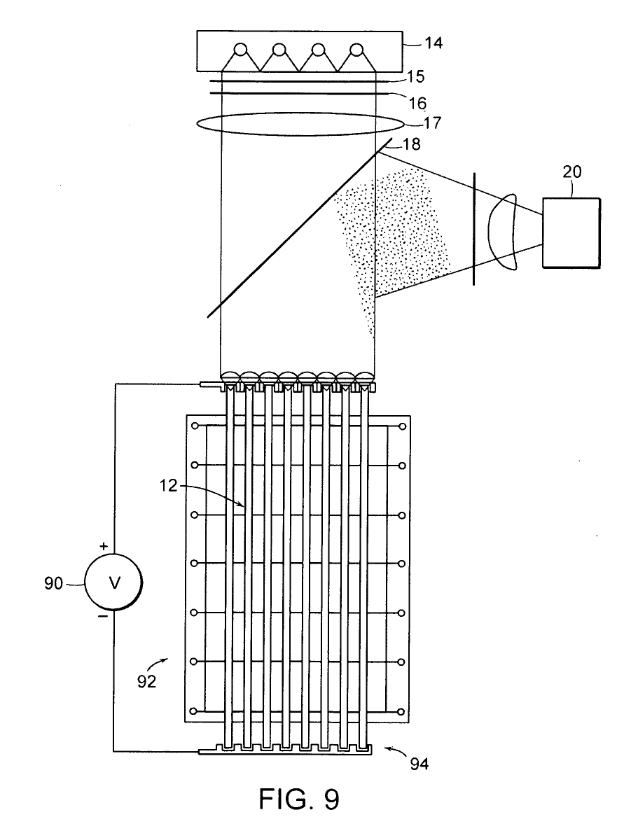

Referring now to FIG. 9, a schematic is shown of a parallel capillary array electrophoresis system in accordance with preferred embodiments of the present invention. Capillaries 12 are representative of arrays of typically 10⁴ such capillaries that may advantageously be used for parallel DNA electrophoresis, with DNA supplied, for example, from DNA micro-well array 94. Capillaries 12 are typically disposed within a thermal control chamber 92. Electric fields, applied by voltage supply 90, as typically employed in electrophoresis applications, are on the order of magnitude of 10-10² V/cm. In typical prior art implementations of parallel electrophoresis capillaries, the capillaries open, at either end, to a buffer reservoir containing buffer solution common to all the capillaries. It is within the scope of the present invention that materials, including DNA, may also be loaded from a buffer well array. An electric potential is applied between two electrodes, one in each buffer reservoir. The potential is thus common to all the electrophoresis columns.

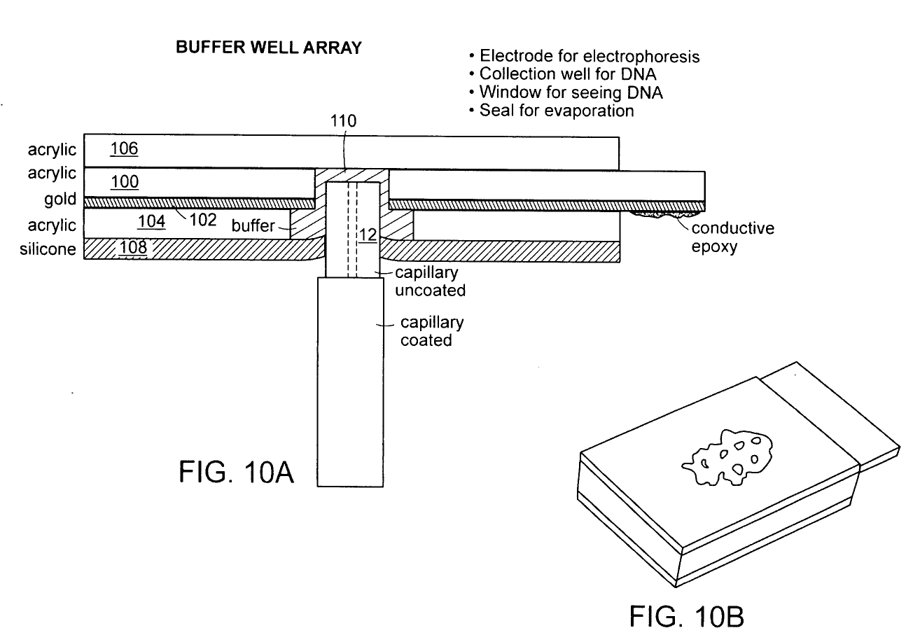

In accordance with other embodiments of the present invention, the capillary ends facing the excitation and end-column readout do not terminate in a common buffer reservoir but, instead, each has an individual buffer well 110, as now described with reference to FIG. 10. A first platen 100, made out of acrylic or another material of approximately 3-mm thickness, has substantially parallel faces and through-holes for receiving each of the ends of capillaries 12. The through-holes may be drilled or punched by any means, including, laser drilling, etc. The first platen 100 need not be transparent. First platen 110 is coated with a conductive coating 102, such as gold or another metal, using standard coating techniques such as evaporation or sputtering, etc. Alternatively, the platen itself may be conductive. The coating, if employed, may be contiguous, providing a common electrode for all the electrophoresis channels, or, alternatively, a separate potential may be applied across each channel. A second platen 104 is also perforated with through-holes, and bonded to the first platen with holes registered as shown. The lower surface of the second platen 104 is coupled to a septum 108, comprised of silicone or another elastomer. Septum 108 can be penetrated by each of the capillaries 12 as shown, sealing against the outer circumference of each capillary. Upon removal of the capillaries, septum 108 ‘repairs itself,’ sealing any retained buffer fluid behind it. Any coating of the capillary is removed from the length of insertion prior to insertion into septum 108. The upper surface of first platen 100 is covered with a transparent platen 106, which may be acrylic or glass, for example. Illumination of the capillary end with excitation radiation is provided through transparent platen 106. The laminate manifold structure described provides a buffer well volume 110 for each of the capillaries.

At least two advantages accrue from buffer well manifold provided in accordance with the invention. Retention of the contents of each buffer allows for the separation of mutant fractions, interim products of each run at a specified point in time, such as when a fluorophore-tagged molecule is identified in one of the channels. To retain the fraction, the ends of the capillary array are withdrawn from septum 108 of the buffer well array, and they are inserted into a new buffer well array for continuation of the electrophoresis run. Moreover, since there is no common buffer region, separate electric potentials may be applied across each of the channels, if desirable.

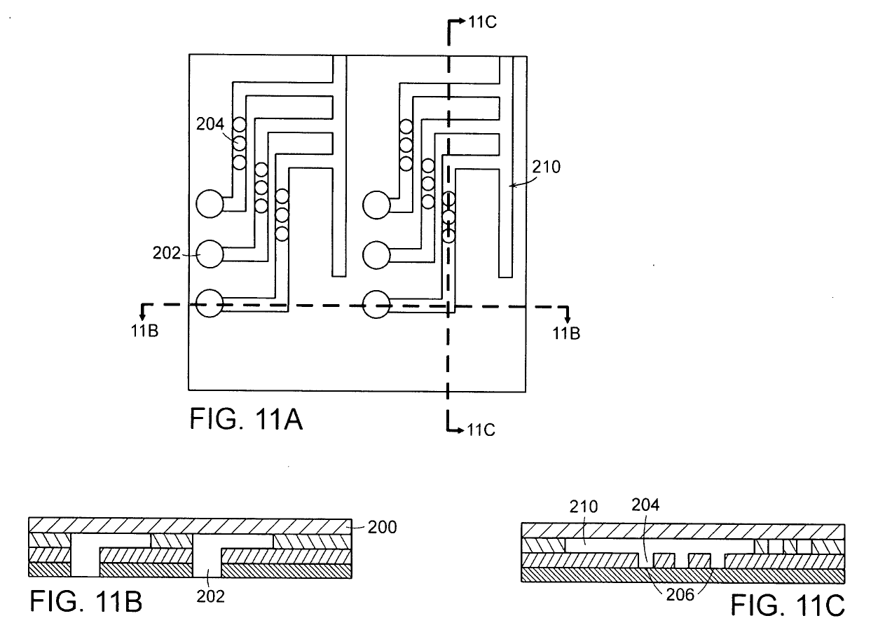

In alternate embodiments of the invention, molecular effluent may be advantageously sequestered during the course of the electrophoresis process using a microfluidic channel plate, as shown in FIGS. 11A-11C. FIG. 11A is a top view of a microfluidic channel plate, designated generally by numeral 200. As shown in the cross section of FIG. 11B, channel plate 200 contains covers a through-hole platen 201 containing one through-hole 202 for each underlying capillary tube, the axis of which extends downward into the page, beneath the channel plate. An array of capillaries, of order 100×100 capillaries is a typical size, with a corresponding number of through-holes 202 arranged in subgroups (such as quadrants, for example) on channel plate 200, of which one subgroup is depicted by way of example. In channel plate 200, effluent from each capillary is drawn to an outflow 208 via channels 210. Channels 210 are formed into channel plate 200 using microfabrication techniques. Plate 200 is preferably electrically insulating, and it may be a semiconductor rendered insulating using standard coating techniques, for example. Channels 210 are preferably of transverse dimensions of order 10 μm wide and 200 μm deep, though these dimensions are given by way of example only. Thus, on the order of 50 such channels are implemented between rows of capillaries spaced on centers on the order of 1 mm.

Imaging of the capillary ends is performed through transparent portions, or windows, of channel plate 200 which may be fabricated of transparent material, such as glass, or may, alternatively, have holes overlying each capillary end, covered, in turn, by a sealing layer of acrylic, or other material. At specified instants, during the course of the eletrophoresis run, such as upon a positive detection of a tagged molecule of interest, effluent may be drawn, from one or more channels 210 into a specified sequestration zone 204, by application of an electric potential to a corresponding electrode 206, without interrupting the flow of the electrophoresis process. Flow through the channels is characterized by an extremely low Reynolds number (typically ≦10⁻⁵) such that flow is in the extreme Poiseuille laminar limit, such that, once deposited in a specified segregation zone, effluent will be retained for later collection and analysis.

The present invention, of which certain embodiments are described herein, may advantageously provide significant increases in throughput over techniques available in the prior art, by virtue of the increased multiplex advantage provided by parallelism of up to 10² more capillary channels than currently possible. Such extensive parallelism appears to be a requirement for many important biological research goals. For instance, best efforts of human geneticists have failed to discover genes encoding genetic risks for common diseases such as prostate cancer and their methods involve expensive pairwise trials of gene/disease association. The present invention incorporated in a system to perform parallel pairwise trials should allow the necessary pan-genomic studies of large numbers of subjects for each of 100 or more common diseases estimated to involve some 10¹² electrophoretic scans of ˜25,000 genes in 10⁶ subjects. The present invention permits dramatic reduction of the estimated costs of gene/disease association.

The described embodiments of the invention are intended to be merely exemplary and numerous variations and modifications will be apparent to those skilled in the art. All such variations and modifications are intended to be within the scope of the present invention as described herein and as defined in any appended claims.

We claim:

1. An electrophoresis system comprising:
a. a plurality of capillaries, each capillary characterized by a longitudinal axis, a first end and a second end, the capillaries aligned such that their longitudinal axes are parallel and their first ends are substantially coplanar;
b. a source of excitation radiation for illuminating the first ends of the plurality of capillaries;
c. an imaging optical arrangement having one or more focal regions, the imaging optical arrangement disposed at a displacement with respect to the substantially coplanar loci so as to place each locus within a focal region of the imaging optical arrangement; and
d. a detector module for receiving electromagnetic radiation emitted by fluorophores within the capillaries upon excitation by the excitation radiation and transmitted to the detector module by way of the imaging optical arrangement.

2. An electrophoresis system according to claim 1, wherein the imaging optical arrangement comprises:
an array of imaging optical elements, each imaging optical element characterized by an area, a numerical aperture, and a focal region.

3. An electrophoresis system according to claim 1, wherein the optical arrangement comprises a telescoping imaging system.

4. An electrophoresis system according to claim 1, wherein the optical arrangement comprises a large-format relay lens.

5. An apparatus for optical interrogation of a plurality of substantially coplanar loci, the apparatus comprising:
a. an imaging optical arrangement having one or more focal regions, the imaging optical arrangement disposed at a displacement with respect to the substantially coplanar loci so as to place each locus within a focal region of the imaging optical arrangement;
b. a source for illuminating each of the plurality of substantially coplanar loci via the imaging optical arrangement;
c. an optical detector for detecting light imaging each of the plurality of substantially coplanar loci after said light has been collected by the imaging optical arrangement.

6. An apparatus according to claim 5, wherein the imaging optical arrangement includes an array of imaging optical elements, each imaging optical element characterized by an area, a numerical aperture, and a focal region.

7. An apparatus according to claim 6, wherein the optical elements are reflecting elements.

8. An apparatus according to claim 6, wherein the optical elements are parabolic reflectors.

9. An apparatus according to claim 6, wherein the optical elements are lenslets.

10. An apparatus according to claim 6, wherein the area and numerical aperture of each optical element is chosen so as to provide an increase in optical collection solid angle for each of the substantially coplanar loci.

11. An apparatus according to claim 6, wherein the numerical aperture of each optical element is greater than 0.3.

12. An apparatus according to claim 6, wherein the source of illumination includes an LED array.

13. An apparatus according to claim 6, wherein the source of illumination includes an array of incoherent light sources and an optical diffuser.

14. An apparatus according to claim 6, wherein the optical detector is a CCD array.

15. An apparatus according to claim 6, wherein the optical detector is an impact-ionizing CCD array.

16. An apparatus according to claim 6, wherein each of the substantially coplanar loci is an end of an electrophoresis column.

17. An apparatus according to claim 6, wherein the substantially planar array of loci are ends of an array of capillaries.

18. A method for optical interrogation of a plurality of substantially coplanar loci, the method comprising:
a. providing an array of imaging optical elements, each optical element characterized by an area, a numerical aperture, and a focal region;
b. disposing the array of imaging optical elements at a displacement with respect to the substantially coplanar loci so as to place each locus within a focal region of one of the optical elements;
c. illuminating the plurality of substantially coplanar loci; and
d. collecting light emitted at the substantially coplanar loci that is transmitted via the imaging optical elements.

19. A method for manufacturing an array of lenslets, comprising:
a. fashioning a plurality of détentes in a mold; and
b. injecting acrylic into the mold.

20. A method according to claim 19, wherein the step of fashioning includes one or more of the steps of milling with a ball-end milling tool, by investment casting, single point diamond turning, or grinding.

21. A manifold for terminating an array of electrophoresis capillaries, the manifold comprising:
a. a first platen having a plurality of recessions for receiving each of a plurality of ends of the array of capillaries; and
b. a septum disposed adjacent to the first platen for penetration by the ends of the array of capillaries when inserted into the first platen.

22. A manifold, according to claim 21, wherein the first platen is electrically conductive.

23. A manifold, according to claim 21, further comprising a conductive layer covering one face of the first platen.

24. A manifold, according to claim 21, further comprising a transparent platen adjacent to the first platen, for admitting light for optical interrogation of the ends of the array of capillaries.

25. A manifold, according to claim 21, wherein the septum includes a silicone layer.

26. A manifold, according to claim 21, wherein the septum retains material from each of the array of capillaries in the manifold upon withdrawal of the array of capillaries.

27. A method for applying an electric potential to one end, or both, of each electrophoresis capillary of an array of electrophoresis capillaries, the method comprising inserting each capillary into a terminating manifold including electrodes maintained at the electric potential with respect to a fiduciary reference.

28. A system for performing electrophoresis on a plurality of samples, the system comprising:
a. a plurality of capillaries, each capillary having a first end and a second end, and each capillary containing a sample loaded into a gel;
b. a terminating manifold including:
(i) a platen having a plurality of recessions for receiving each of a plurality of first ends of the array of capillaries;
(ii) a conducting layer covering the platen adjacent to each or several of the plurality of recessions; and
(iii) a septum disposed adjacent to the conductive layer for penetration by the first ends of the array of capillaries when inserted into the first platen;
c. a circuit for applying an electrical potential between the first ends of the array of capillaries and the second ends of the array of capillaries.

29. A method for separating products from an electrophoresis run, the method comprising:
a. injecting gel into an array of capillaries, the capillaries characterized by a proximal end and a distal end;
b. loading dye-labeled organic sample into the proximal ends of each of the capillaries;
c. terminating the distal ends of the capillaries in a terminating manifold having a buffer well corresponding to each capillary;
d. applying an electrical potential across each of the capillaries;
e. illuminating the array of capillaries with dye-exciting light; and
f. upon detecting a fluorescence signal from at least one of the capillary ends, segregating effluent from one or more capillaries of the array.

30. A method according to claim 29, wherein the step of segregating effluent includes withdrawing the array of capillaries from the terminating manifold, thereby retaining a fraction of the organic sample in each of the buffer wells.
